(19) United States
(12) Patent Application Publication
(10) Pub. No.: US 2003/0050850 A1
(43) Pub. Date: Mar. 13, 2003

(54) Payment trigger

(76) Inventor: Robert Sesek, Meridian, ID (US)

Correspondence Address: HEWLETT-PACKARD COMPANY, Intellectual Property Administration, P.O. Box 272400, Fort Collins, CO, 80527-2400, US

(21) Appl. No.: 09/954,606

(22) Filed: Sep. 10, 2001

(51) Int. Cl. G06F 17/60

(52) U.S. Cl. 705/26

(57) ABSTRACT

A method and system for triggering payment for goods upon delivery. A seller receives an order to deliver a specified good along with authorization to request payment for the goods from a particular account. Upon delivery of the goods, payment is requested from the account. In one embodiment, release of the goods may not be authorized until payment is verified.

### FIELD OF THE INVENTION

The present invention relates generally to a system for payment of goods, and more particularly, to a system and method for triggering payment for goods upon delivery.

### BACKGROUND OF THE INVENTION

When a customer purchases goods directly, groceries for example, the customer selects goods from a shelf, carts those goods to a cashier, and pays. The grocery store receives payment, the customer takes possession of the groceries, and the transaction is complete. Indirect transactions are often, however, not so simple. For example, when purchasing goods over the Internet or through a catalog or telephone service, companies typically require payment prior to shipment of the goods.

Prepayment schemes are in place to ensure the provider of the goods gets paid while providing little or no benefit to the purchaser of the goods or services. Someone may order a piece of furniture over the Internet supplying a credit card account number for payment. The purchase is charged to the credit card right away, but delivery of the furniture may take weeks especially if the item is temporarily out of stock or must be custom manufactured. The purchaser must then either pay the credit card bill to avoid finance charges or maintain a credit balance. The purchaser in the above example may be a reseller who has specially ordered goods for its customer. Unless the reseller can obtain prepayment from the customer, the reseller is forced to cover the cost of the goods until delivered—decreasing the reseller's cash flow or requiring the reseller to incur finance charges.

What is needed is a system and method for triggering payment for goods upon delivery. The system and method would ensure payment without unduly burdening the purchaser.

### SUMMARY OF THE INVENTION

The present invention is directed to a method and system for triggering payment for goods upon delivery. A seller receives an order to deliver a specified good along with authorization to request payment for the goods from a particular account. Upon delivery of the goods, payment is requested from the account. In one embodiment, release of the goods may not be authorized until payment is verified.

### DESCRIPTION OF THE DRAWINGS

FIG. 1 is a schematic representation of a transaction environment for the delivery and payment of goods that includes a buyer, a seller, a shipper, an account, a delivery device, and a ticket.

FIG. 2. is a block diagram further illustrating the components of the ticket according to one embodiment of the present invention.

FIG. 3 is a block diagram further illustrating the logical components of the delivery device according to one embodiment of the present invention.

FIG. 4 is a block diagram of a delivery record according to one embodiment of the present invention.

FIG. 5 is a flow diagram illustrating the transaction for delivery and payment of goods according to one embodiment of the present invention.

### DETAILED DESCRIPTION OF THE INVENTION

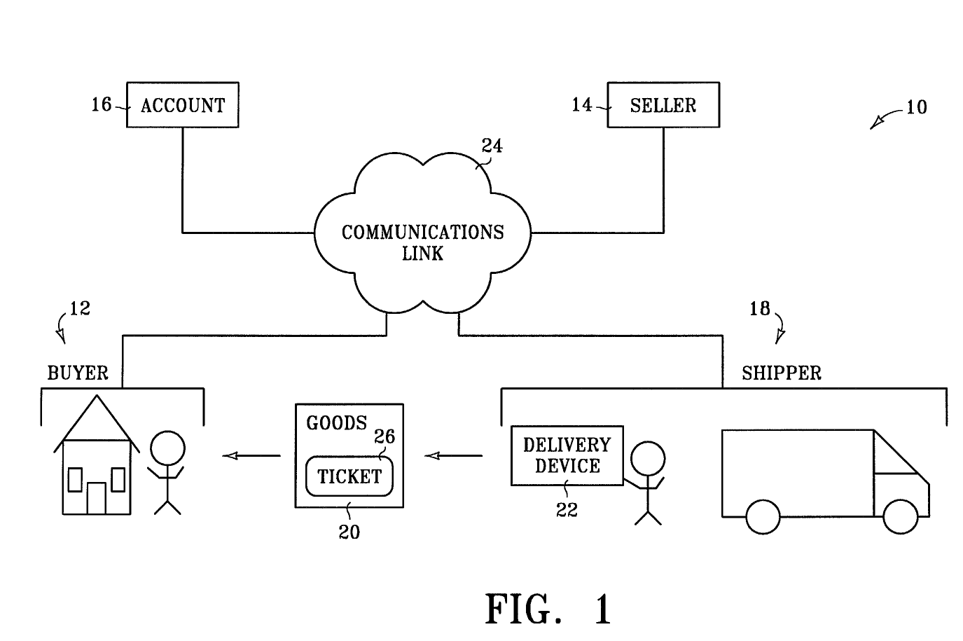

COMPONENTS: FIG. 1 illustrates schematically a transaction environment 10 for the delivery and payment of goods. Although the various embodiments of the invention disclosed herein will be described with reference to environment 10, the invention is not limited to use with environment 10. The invention may be implemented in or used within any environment in which it is necessary or desirable to deliver and receive payment for goods. The following description and the drawings illustrate only a few exemplary embodiments of the invention. Other embodiments, forms, and details may be made without departing from the spirit and scope of the invention, which is expressed in the claims that follow this description.

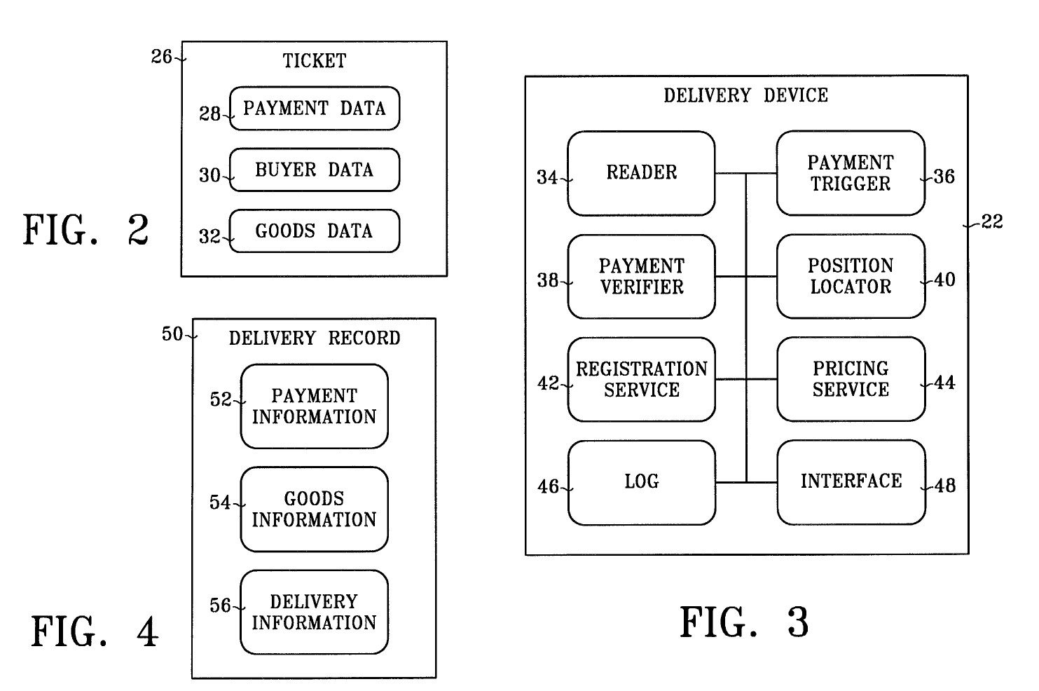

Referring to FIG. 1, environment 10 includes buyer 12, seller 14, account 16, shipper 18, goods 20, and delivery device 22, and communications link 24. Buyer 12, seller 14, and shipper 18 represent respectively individuals or business entities ordering, selling, or shipping goods 20. Although FIG. 1 illustrates buyer 12 receiving goods 20, buyer 12 need not be the recipient. Buyer 12 may order goods for delivery to another business or individual. Account 16 represents generally any source of funds used to pay for goods 20. Account 16 may be a debit account such as escrow, checking, or savings account or it may be a credit account such as a line of credit or credit card account. Referring to FIGS. 1 and 2, ticket 26, associated with goods 20, represents generally any source of information representing payment, buyer, and goods data 28, 30 and 32. Payment data 28 includes authorization to obtain payment for the goods 20 from account 16. Buyer data 30 typically includes information identifying the buyer such as the buyer's name and billing address as well as a shipping address when different from the billing address. It is envisioned that goods 20 may be delivered to a recipient other than the buyer. In such cases, buyer data 30 also includes the name and address or other identifier of the intended recipient. Goods data 32 contains information identifying the goods 20 such as serial numbers, the date of manufacture and other characteristics of goods 20.

Delivery device 22 represents generally any combination of hardware and programming capable of reading information from ticket 26. For example, if ticket 26 uses bar codes, then delivery device 22 includes an optical scanner and supporting programming to read bar codes. If ticket 26 instead uses an e-label or other electronic file stored in a storage medium affixed to goods 20 or in a storage medium delivered along with goods 20, then delivery device 22 is a computing device capable of reading and interpreting the electronic data stored within that medium. Many other possibilities exist. Ticket 26 need only contain information relating to payment data 28 and delivery device 22 need only be capable of reading and processing the information from ticket 26. Ticket 26 need not actually contain the data, but rather it need only provide information concerning how to access such information. For example, if seller 14 stores data 28, 30, and 32 as a record in a central database, then ticket 26 need only contain information identifying that record. In one such example, ticket 26 may represent a URL (Uniform Resource Locator) which is linked to data 28, 30 and 32. Alternatively, ticket 26 may actually contain payment, buyer, and goods data 28, 30, and 32.

Communications link 24 interconnects buyer 12, seller 14, account 16 and shipper 18. Communication link 24 represents generally any mode of communication including a cable, wireless, or remote connection via a telecommunication link, an infrared link, a radio frequency link, or any other connector or system that provides electronic or voice communication. Communication link 24 may represent a telephone voice or facsimile link, an intranet, the Internet, or a combination of any of the above.

FIG. 3 further illustrates the logical components of delivery device 22. Delivery device 22 includes reader 34, payment trigger 36, payment verifier 38, and position locator 40. Reader 34 represents generally any combination of hardware and programming capable of acquiring and processing information from ticket 26. Payment trigger 36 represents any programming capable of initiating payment from an account identified using information from ticket 26. Payment verifier 38 represents generally any programming capable of confirming that payment has been made or otherwise approved from the account identified by ticket 26. Position locator 40 represents a combination of hardware and programming capable of identifying the physical location of goods 20 as ticket 26 is being read. It is envisioned that position locator 40 will incorporate a Global Positioning System (GPS) receiver and programming capable of recording the physical location of the goods 20 as reader 34 acquires information from ticket 26. Such information can be used to confirm that the goods were delivered to the correct address or location if there is not an associated address.

In the embodiment illustrated in FIG. 3, delivery device 22 also includes registration service 42 and pricing service 44. Registration service 42 represents generally any programming capable of initiating the registration of goods 20. For warranty purposes many sellers request or require buyer 12 register goods 20—typically providing seller 14 with a serial number or other identifying information, a purchase date, and information identifying buyer 12 such as a name and address. Registration service 42 creates a registration record recording the delivery date and the information acquired by reader 34 identifying payment, buyer, and goods data 28, 30, and 32.

Pricing service 44 represents any programming capable of calculating a purchase price for the goods 20. In many cases it may be desirable to base the purchase price for goods 20 based in part upon a delivery time, that is, the time between when goods 20 were ordered when goods 20 are delivered. In such cases, ticket 26 contains pricing data needed by pricing service 44 to determine the purchase price. For example, pricing data may indicate one purchase price if the goods are delivered within two days and a second purchase price if delivered later. As reader 34 acquires the information from ticket 26, pricing service 44 determines the delivery date and calculates the purchase price according to the pricing data and payment trigger 36 initiates payment for the goods in the amount of the calculated purchase price.

Log 46 represents a memory area capable of storing electronic data used and provided by reader 34, payment trigger 36, payment verifier 38, position locator 40, and registration and pricing services 42 and 44. Interface 48 represents generally hardware, programming or any combination of hardware and programming capable of transmitting and receiving electronic data allowing delivery device 22 to connect to communications link 24. Interface 48 may incorporate a wireless modem or other similar mechanism allowing delivery device 22 to communicate directly in real time with seller 14 and/or account 16. When initiating payment, payment trigger 36 can cause device 22 to transmit payment data 28 or information identifying payment data 28 (including a calculated purchase price) to seller 14 or directly to account 16. Seller 14 then can acquire funds from account 16. If communicating in real time, payment verifier 38 can confirm that payment from account 16 has been made or otherwise approved and authorize release of goods 20 just as if a credit card had been swiped at a retail store.

It is envisioned that as goods 20 are delivered, delivery device 22 will read ticket 26 identifying payment, buyer, and goods data 28, 30, and 32. Delivery device 22 will generate a delivery record 50, illustrated in FIG. 4, to be stored in log 46. Delivery record 50 will contain payment, goods, and delivery information 52, 54, and 56. Payment information 52 will include information acquired by reader 34 identifying payment data 28 as well as a calculated purchase price when appropriate. Goods information 54 will include data provided or used by registration service 42. Delivery information 56 will include physical coordinates recorded by position locator 40 and perhaps electronic data representing the signature and/or other identifier of the recipient of goods 20. The record can be stored within log 46 and retrieved as necessary. This is useful when delivery device 22 cannot communicate with seller 14 or account 16 in real time. In such a case shipper 18 can return to a central office or other location where delivery device can connect to communication link 24 and transmit a delivery record to seller 14 and/or account 16.

FIG. 3 illustrates components 34 through 48 as being contained on delivery device 22. However, one or more of the components 36 through 46 may be located elsewhere. For example, position locator 40 may be positioned in a delivery vehicle and configured to communicate via radio frequency or other means with delivery device 22. The same can be said for payment trigger and verifier 36 and 38, registration pricing services 42 and 44 as well as log 46.

The block diagrams of FIGS. 1-3 show the architecture, functionality, and operation of one implementation of the present invention. If embodied in software or other programming, each block may represent a module, segment, or portion of code that comprises one or more executable instructions to implement the specified logical function(s). If embodied in hardware, each block may represent a circuit or a number of interconnected circuits to implement the specified logical function(s).

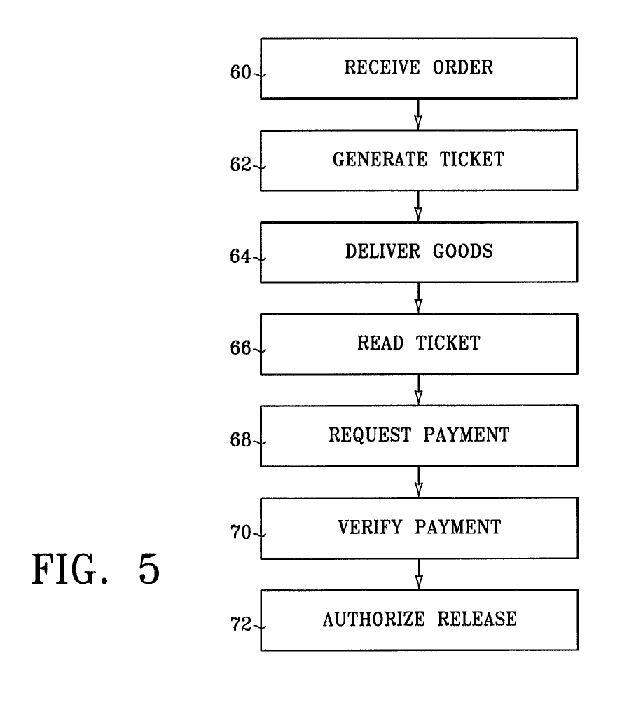

OPERATION: The operation of one embodiment of the present invention will now be described with reference to the flow diagram of FIG. 5, which provides an example of the steps taken to complete a transaction for goods utilizing the present invention.

Seller receives an order from buyer for specified goods (step 60). The order may be received electronically, via telephone, facsimile, mail, or any other manner. Included in the order is buyer data 30 and payment data 28 authorizing payment for the goods from a specified account 16 upon delivery. Account 16 may be an account provided by seller 14 or a third party such as a bank or escrow service. Where an account provided by a third party is used, seller 14 may place a hold on the account for the purchase price. Where the account is a credit account, the hold would ensure that the buyer has a sufficient amount of credit available when the goods are actually delivered.

Seller 14 then creates an order record containing payment and buyer data 28 and 30 as well as goods data 32 when available. Prior to shipment, seller 14 generates a ticket 26 to be delivered with the goods (step 62). The ticket 26 may be affixed to the goods but need only be accessible to shipper 18 when the goods 20 are delivered. The ticket 26 may either contain information identifying the order record, or the order record or portions thereof may be stored on the ticket 26. Seller 14 then delivers or hires a third party shipper 18 to deliver the goods to buyer (step 64). Upon delivery, shipper 18, using delivery device 22, reads ticket 26 (step 66). Using information representing payment data 28 acquired from ticket 26, delivery device 22 initiates a request for payment (step 68). Where payment data 28 can be obtained directly from ticket 26, delivery device 22 may communicate with a party responsible for account 16 and request that funds be transferred from account 16 to seller 14. Alternatively, delivery device 22 may complete step 68 by transmitting information identifying payment data 28 to seller 14 informing seller 14 that delivery has been made. Seller 14 then requests funds from account 16 as indicated and authorized in payment data 28. Before releasing goods 20, delivery device 22 may obtain verification that payment has been made or otherwise approved (step 70). Upon verification of payment, delivery device 22 authorizes shipper 18 to release goods 20 (step 72).

When reading ticket 26 in step 66, delivery device 22 may also acquire information identifying buyer and goods data and initiate product registration. To do so, delivery device 22 transmits the delivery date along with the information identifying buyer and goods data to seller 14. Upon reading ticket 26, delivery device 22 may also record the recipient's physical location.

Initiating a request for payment in step 68 may be accomplished by first calculating a purchase price based in part on the delivery time—that is, the time it takes to process the order and physically deliver the goods. In this case, ticket 26 includes pricing data. As ticket 26 is read in step 66, delivery device 22 acquires pricing data, notes the delivery time, and calculates the purchase price accordingly. Delivery device 22 then initiates a request for payment in the amount of the calculated purchase price.

Where interface 48 incorporates a wireless modem or other mechanism enabling delivery device 22 to communicate remotely with seller 14 and/or account 16, a request for payment may be initiated in real time shortly after the ticket 26 is read. The same is true for payment verification and product registration. Alternatively, interface 48 may incorporate a storage mechanism such as a removable media drive allowing delivery records 50 to be stored in nonvolatile memory such as on a floppy disk. When shipper 18 returns to a central location, delivery records 50 can be transmitted to seller 14 and/or account 16. Interface 48 may also enable delivery device to physically connect to a computer network in order transmit delivery records 50. Such a transmission could be made via e-mail or through a direct network connection, or even through traditional mail delivery.

Although the flow chart of FIG. 5 shows a specific order of execution, the order of execution may differ from that which is depicted. For example, the order of execution of two or more blocks may be scrambled relative to the order shown. Also, two or more blocks shown in succession in FIG. 5 may be executed concurrently or with partial concurrence. All such variations are within the scope of the present invention.

The present invention has been shown and described with reference to the foregoing exemplary embodiments. It is to be understood, however, that other forms, details, and embodiments may be made without departing from the spirit and scope of the invention which is defined in the following claims.

What is claimed is:

1. A method for conducting a transaction comprising:
receiving an order to deliver a good;
receiving authorization to request payment from an account;
generating a ticket containing information relating to the authorization;
delivering the ordered good;
reading the ticket;
requesting payment upon delivery from the account.

2. The method of claim 1, wherein the act of receiving authorization comprises receiving authorization to charge the account and the act of requesting payment comprises charging the account.

3. The method of claim 2, wherein further comprises placing a hold on the account for a purchase price of the good.

4. The method of claim 1, wherein the act of receiving authorization comprises receiving authorization to draw funds on the account and the act of requesting payment comprises drawing funds on the account.

5. The method of claim 1, further comprising authorizing release of the good only if the request for payment is approved.

6. The method of claim 1, wherein the act of shipping comprises generating a ticket to be associated with the good, the ticket having readable information representing payment data, and the act of requesting payment comprises reading the ticket upon delivery and requesting payment according to the payment information.

7. The method of claim 6, wherein the tag further contains readable information representing buyer and good data, the method further comprises registering the good according to the buyer and good data upon delivery.

8. The method of claim 1, further comprising, upon delivery of the good, recording a recipient's physical location to verify that the good has been delivered to a correct address.

9. The method of claim 1, further comprising determining a delivery time and calculating a purchase price according to the delivery time and wherein the act of requesting payment comprises requesting payment in the amount of the calculated purchase price.

10. A computer program product for triggering payment for delivered goods, the product comprising a computer useable medium having machine readable instructions thereon for:
reading a ticket associated with the goods, the ticket having information representing payment data for the delivered goods; and
initiating payment for the delivered goods according to the information.

11. The product of claim 10, wherein the payment data includes authorization to draw funds on a debit account and the instructions for initiating payment comprise instructions for prompting the drawing of funds on the account.

12. The product of claim 10, wherein the payment data includes authorization to draw funds on a credit account and the instructions for initiating payment comprise instructions for prompting the charging of the account.

13. The product of claim 10, comprising further instructions for verifying payment and authorizing release of the goods only upon verification.

14. The product of claim 10, comprising further instructions for acquiring the physical location of a recipient of the delivered goods.

15. The product of claim 10, wherein the ticket further includes information representing buyer and good data, the product comprising further instructions initiating registration of the delivered goods according to the buyer and goods data.

16. The product of claim 10, comprising further instructions for determining a delivery time and calculating a purchase price according to the delivery time, and wherein the instructions for initiating payment comprise prompting payment in the amount of the calculated purchase price.

17. A system for payment of delivered goods comprising:
a ticket delivered with the goods, the ticket containing information representing an account from which payment for the goods will be received; and
a delivery device operable to read the ticket upon delivery of the goods and to trigger payment from the account.

18. The system of claim 17, wherein the delivery device includes:
a reader operable to read the information from the ticket; and
a payment trigger operable to initiate payment from the account.

19. The system of claim 18, further comprising a payment verifier in communication with the reader and operable to verify payment from the account and to authorize release of the goods only upon verification.

20. The system of claim 18, further comprising a position locator in communication with the reader operable to identify the physical location of the recipient of the goods as the reader reads the ticket.

21. The system of claim 18 wherein the ticket further contains information representing buyer and good data, and the delivery device is further operable to read the buyer and good data; the system further comprising a registration service in communication with the reader and operable to generate registration data according to the buyer and good data.

22. The system of claim 18, wherein delivery device further includes an interface operable facilitate electronic communication between the delivery device and one or more other devices.

23. The system of claim 18, further comprising a pricing service in communication with the reader and the payment trigger, the pricing service operable to determine a delivery time and to calculate purchase price according to the delivery time, the payment trigger being further operable to initiate payment from the account in the amount of the calculated purchase price.
